(19) United States
(12) Patent Application Publication
(10) Pub. No.: US 2023/0244107 A1
(43) Pub. Date: Aug. 3, 2023

(54) OPTICAL FILM STACK FOR DIRECT BACKLIGHT UNIT

(71) Applicant: 3M INNOVATIVE PROPERTIES COMPANY, St. Paul, MN (US)

(72) Inventors: Yu Hsin Lu, Dacun Township (TW); Gary T. Boyd, Woodbury, MN (US)

(21) Appl. No.: 18/102,844

(22) Filed: Jan. 30, 2023

Related U.S. Application Data
(60) Provisional application No. 63/305,431, filed on Feb. 1, 2022.

(51) Int. Cl. G02F 1/1335; G02F 1/13357

(52) U.S. Cl. CPC G02F 1/133607; G02F 1/133614; G02F 1/13362; G02F 1/133605; G02B 5/305

(57) ABSTRACT

A backlight to a display panel including a plurality of discrete spaced apart light sources configured to emit light and arranged two-dimensionally on a first substrate substantially reflective at least in regions between the light sources, a reflective polarizer disposed on the plurality of discrete spaced apart light sources, a first optical diffuser disposed between the reflective polarizer and the plurality of light sources and having a plurality of positive microlenses arranged in a regular two-dimensional array, and a second optical diffuser disposed between the reflective polarizer and the plurality of light sources and having a plurality of retroreflective elements arranged in a regular two-dimensional array. The second optical diffuser is configured to receive the emitted light and retroreflect the received light for incident angles less than a predetermined threshold value and transmit at least 60% of the received light for incident angles greater than the predetermined threshold value.

### SUMMARY

In some aspects of the present description, a backlight for providing illumination to a display panel is provided, the backlight including a plurality of discrete spaced apart light sources configured to emit light and arranged two-dimensionally on a first substrate substantially reflective at least in regions between the light sources, a reflective polarizer disposed on the plurality of discrete spaced apart light sources, a first optical diffuser disposed between the reflective polarizer and the plurality of light sources and having a plurality of positive microlenses arranged in a regular two-dimensional array, and a second optical diffuser disposed between the reflective polarizer and the plurality of light sources and having a plurality of retroreflective elements arranged in a regular two-dimensional array. The second optical diffuser is configured to receive the emitted light and retroreflect the received light for incident angles less than a predetermined threshold value and transmit at least 60% of the received light for incident angles greater than the predetermined threshold value. The reflective polarizer and the first and second optical diffusers are substantially co-extensive in length and width with the plurality of light sources. For a substantially normally incident light and for a visible wavelength range extending from about 420 nm to about 680 nm, the reflective polarizer has an average optical reflectance of at least 60% when the incident light is polarized along an in-plane first direction and an average optical transmittance of at least 60% when the incident light is polarized along an in-plane orthogonal second direction.

In some aspects of the present description, an optical stack for use in a backlight for providing illumination to a display panel is provided, the optical stack including an optical diffuser having a plurality of retroreflective elements arranged in a regular two-dimensional array, and an optical filter disposed on, and substantially co-extensive in length and width with, the optical diffuser. The optical diffuser is configured to receive a first light at a first wavelength emitted by a light source of the backlight and retroreflect the received first light for incident angles less than a predetermined threshold value and transmit at least 60% of the received first light for incident angles greater than the predetermined threshold value. The optical filter includes a plurality of polymeric layers numbering at least 10 in total, and each of the polymeric layers having an average thickness of less than about 500 nm. For the first wavelength, the optical filter has an optical transmittance of greater than about 60% for a first incident angle less than about 10 degrees and an optical transmittance of less than about 50% for a second incident angle greater that about 40 degrees.

### BRIEF DESCRIPTION OF THE DRAWINGS

FIG. 1 is a side view of an optical stack for use in a backlight, in accordance with an embodiment of the present description;

FIG. 2 is a side view of a display system, in accordance with an embodiment of the present description;

FIG. 3 is a chart plotting the optical characteristics of a backlight, in accordance with an embodiment of the present description;

FIG. 4 is a side view of an optically diffusing film featuring a plurality of retroreflective elements, in accordance with an embodiment of the present description;

FIG. 5 is a side view of an optically diffusing film featuring a plurality of retroreflective elements, in accordance with an embodiment of the present description;

FIG. 6 is a side view showing a typical structure for a multilayer optical film, in accordance with an embodiment of the present description;

FIG. 7 shows an embodiment of a retroreflective element based on a cube corner structure, in accordance with an embodiment of the present description;

FIG. 8 shows an alternate embodiment of a retroreflective element based on a spherical bead, in accordance with an embodiment of the present description; and

FIGS. 9A and 9B include a chart and summary table showing optical characteristics for an optical filter for use in an optical stack, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Electronic devices such as computers and smart mobile devices often include a backlit display, such as a liquid crystal display. These displays typically include a backlight unit for providing illumination to the display. For example, edge-lit backlight units have light-emitting diodes that emit light into an edge surface of a light guide plate, where the light is distributed laterally across the display to serve as backlight illumination. Another example is the direct-lit backlight units, which have two-dimensional arrays of light sources (e.g., light-emitting diodes) that emit light vertically through the display. However, direct-lit backlight units can be bulky and may produce non-uniform backlight illumination.

According to some aspects of the present description, a display system including a display (e.g., a liquid crystal display) illuminated by a backlight unit. The backlight unit includes a substrate (e.g., a printed circuit board), a plurality of light sources mounted on the substrate, a reflective polarizer, and a light spreading film stack formed over the printed circuit board that spreads light received from the plurality of light sources. The light spreading film stack includes a light expanding film under a partially reflective layer. In some embodiments, the backlight unit may further include one or more of a color conversion layer, a brightness enhancement film, and a diffuser.

According to some aspects of the present description, a backlight for providing illumination to a display panel may include a plurality of discrete spaced apart light sources (e.g., light-emitting diodes) configured to emit light and arranged two-dimensionally on a first substrate substantially reflective at least in regions between the light sources, a reflective polarizer disposed on the plurality of discrete spaced apart light sources, a first optical diffuser disposed between the reflective polarizer and the plurality of light sources and having a plurality of positive microlenses arranged in a regular two-dimensional array, and a second optical diffuser disposed between the reflective polarizer and the plurality of light sources and having a plurality of retroreflective elements arranged in a regular two-dimensional array.

In some embodiments, the positive microlenses in the plurality of positive microlenses may be disposed on a common second substrate. In some embodiments, the regions of the first substrate between the light sources may have an average optical reflectance of at least 50%, or at least 60%, or at least 70%, or at least 80%, or at least 90% in the visible wavelength range.

In some embodiments, the second optical diffuser may be configured to receive the emitted light and retroreflect the received light for incident angles less than a predetermined threshold value and transmit at least 60%, or at least 65%, or at least 70%, or at least 75%, or at least 80%, or at least 85%, or at least 90% of the received light for incident angles greater than the predetermined threshold value. In some embodiments, the reflective polarizer and the first and second optical diffusers may be substantially co-extensive in length and width with the plurality of light sources. In some embodiments, for a substantially normally incident light and for a visible wavelength range extending from about 420 nm to about 680 nm, the reflective polarizer may have an average optical reflectance of at least 60%, or at least 70%, or at least 80%, or at least 90%, or at least 95% when the incident light is polarized along an in-plane first direction (e.g., along the x-axis of the reflective polarizer) and an average optical transmittance of at least 60%, or at least 70%, or at least 80%, or at least 90%, or at least 95% when the incident light is polarized along an in-plane orthogonal second direction (e.g., along the y-axis of the reflective polarizer).

In some embodiments, at least one of the light sources in the plurality of discrete spaced apart light sources may be configured to emit ultraviolet light having a wavelength less than about 420 nm. In some embodiments, at least one of the light sources in the plurality of discrete spaced apart light sources may be a blue light emitting light source configured to emit blue light having a wavelength between about 420 nm and about 480 nm. In some embodiments, at least one of the light sources in the plurality of discrete spaced apart light sources may be a green light emitting light source configured to emit green light having a wavelength between about 490 nm and about 560 nm. In some embodiments, at least one of the light sources in the plurality of discrete spaced apart light sources may be a red light emitting light source configured to emit red light having a wavelength between about 590 nm and about 670 nm.

In some embodiments, the reflective polarizer may include a plurality of polymeric layers numbering at least 10, or at least 50, or at least 100, or at least 200, or at least 300, or at least 400, or at least 500 in total. In some embodiments, each of the polymeric layers may have an average thickness of less than about 500 nm, or less than about 400 nm, or less than about 300 nm, or less than about 200 nm, or less than about 150 nm, or less than about 100 nm. In some embodiments, the reflective polarizer may further include at least one skin layer disposed on the plurality of polymeric layers and having an average thickness of greater than about 500 nm, or about 750 nm, or about 1000 nm.

In some embodiments, the positive microlenses in the plurality of positive microlenses may have focal lengths between about 10 microns and about 100 microns. In some embodiments, in a plan view (e.g., along a z-axis or thickness direction of the first optical diffuser, the positive microlenses in the plurality of positive microlenses may cover greater than about 60%, or greater than about 65%, or greater than about 70%, or greater than about 75%, or greater than about 80%, or greater than about 85%, or greater than about 90% of the first optical diffuser.

In some embodiments, the backlight may further include a light converting film disposed between the reflective polarizer and the plurality of discrete spaced apart light sources. In some embodiments, the light converting film (e.g., color filters) may include one or more light converting materials configured to receive the emitted light from the light sources and convert at least portions of the received emitted light to blue, green, and red lights. In such embodiments, the backlight may further include an optical filter disposed between the light converting film and the second optical diffuser. In some embodiments, the optical filter may include a plurality of polymeric layers numbering at least 10, or at least 50, or at least 100, or at least 200, or at least 300, or at least 400, or at least 500 in total. In some embodiments, each of the polymeric layers may have an average thickness of less than about 500 nm, or about 400 nm, or about 300 nm, or about 200 nm, or about 150 nm, or about 100 nm. In such embodiments, for a substantially normally incident light polarized along each of the first and second directions, the optical filter may have an average optical transmittance of greater than about 50%, or greater than about 55%, or greater than about 60%, or greater than about 65%, or greater than about 70%, or greater than about 75%, or greater than about 80%, or greater than about 85% for a blue wavelength range extending from about 420 nm to about 480 nm and an optical reflectance of greater than about 50%, or about 55%, or about 60%, or about 65%, or about 70%, or about 75%, or about 80%, or about 85%, or about 90% for each of a green wavelength range extending from about 490 nm to about 520 nm and a red wavelength range extending from about 530 nm to about 680 nm.

In some embodiments, the retroreflective elements of the second optical diffuser include at least one optical interface embedded in the second optical diffuser and configured to totally internally reflect the received light for the incident angles less than the predetermined threshold value. In some embodiments, at least one of the retroreflective elements of the second optical diffuser comprises a pyramid having at least three sides meeting at a peak having at least three peak angles formed by adjacent sides in the at least three sides. In some embodiments, the at least three sides may be configured to totally internally reflect the received light for the incident angles less than the predetermined threshold value. In some such embodiments, each of the at least three peak angles may be between about 85 degrees and about 95 degrees. In some embodiments, at least one of the retroreflective elements of the second optical diffuser may include a substantially spherical solid bead partially embedded in a material to define an optical interface therebetween the material and the bead, the optical interface configured to totally internally reflect the received light for the incident angles less than the predetermined threshold value.

Some embodiments of the backlight may further include additional layers and films. For example, in some embodiments, the backlight may further include one or more third optical diffusers disposed between the second optical diffuser and the light sources and configured to scatter the emitted light. In some such embodiments, the backlight may further include one or more fourth optical diffusers disposed between the reflective polarizer and the first optical diffuser and configured to scatter the emitted light. In some embodiments, the backlight may further include a first prismatic film (e.g., a collimating film or brightness enhancement film) disposed between the reflective polarizer and the light sources and having a plurality of first prisms extending along a first longitudinal direction (e.g., a y-axis of the backlight assembly). In some such embodiments, the backlight may further include a second prismatic film disposed between the reflective polarizer and the first prismatic film and having a plurality of second prisms extending along a second longitudinal direction (e.g., an x-axis of the backlight assembly) different than the first longitudinal direction.

In some embodiments, a display system may include a display panel disposed on any of the backlights described herein. In some embodiments, the display panel may be configured to receive light emitted by the backlight and to form an image for viewing by a viewer.

According to some aspects of the present description, an optical stack for use in a backlight for providing illumination to a display panel may include an optical diffuser having a plurality of retroreflective elements arranged in a regular two-dimensional array, and an optical filter disposed on, and substantially co-extensive in length and width with, the optical diffuser.

In some embodiments, the optical diffuser may be configured to receive a first light at a first wavelength emitted by a light source of the backlight and retroreflect the received first light for incident angles less than a predetermined threshold value, and to transmit at least 60%, or at least 65%, or at least 70%, or at least 75%, or at least 80%, or at least 85%, or at least 90% of the received first light for incident angles greater than the predetermined threshold value.

In some embodiments, the optical filter may include a plurality of polymeric layers numbering at least 10, or at least 50, or at least 100, or at least 200, or at least 300, or at least 400, or at least 500 in total. In some embodiments, each of the polymeric layers may have an average thickness of less than about 500 nm, or greater than about 400 nm, or greater than about 300 nm, or greater than about 200 nm, or greater than about 150 nm, or greater than about 100 nm.

In some embodiments, for the first wavelength, the optical filter may have an optical transmittance of greater than about 60%, or greater than about 65%, or greater than about 70%, or greater than about 75%, or greater than about 80%, or greater than about 85% for a first incident angle less than about 10 degrees, or less than about 8 degrees, or less than about 6 degrees, or less than about 4 degrees, or less than about 2 degrees, or less than about 1 degree and an optical transmittance of less than about 50%, or less than about 45%, or less than about 40%, or less than about 35%, or less than about 30%, or less than about 250%, of less than about 20% for a second incident angle greater that about 40 degrees, or greater than about 45 degrees, or greater than about 50 degrees, or greater than about 55 degrees, or greater than about 60 degrees.

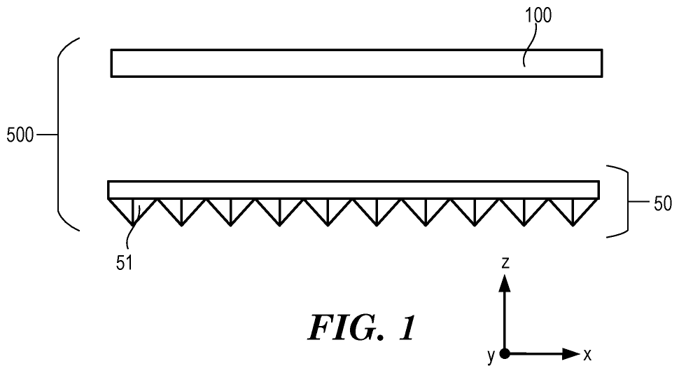

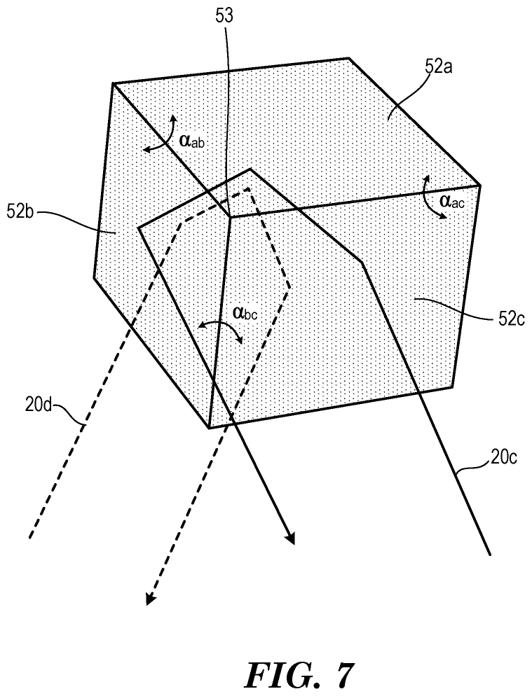

Turning now to the figures, FIG. 1 is a side view of one embodiment of an optical stack for use in a backlight for providing illumination to a display panel, according to the present description. Optical stack 500 includes and optical diffuser 50 and an optical filter 100 disposed on, and substantially co-extensive in length (e.g., the x-axis shown in FIG. 1) and width (e.g., the y-axis) with, the optical diffuser. In some embodiments, optical diffuser 50 may include a plurality of retroreflective elements 51 arranged in a regular two-dimensional array. In some embodiments, an optical filter may include a plurality of polymeric layers numbering at least 10, or at least 50, or at least 100, or at least 200, or at least 300, or at least 400, or at least 500 in total, and each of the polymeric layers may have an average thickness of less than about 500 nm, or less than about 400 nm, or less than about 300 nm, or less than about 200 nm, or less than about 150 nm, or less than about 100 nm (see also FIG. 7).

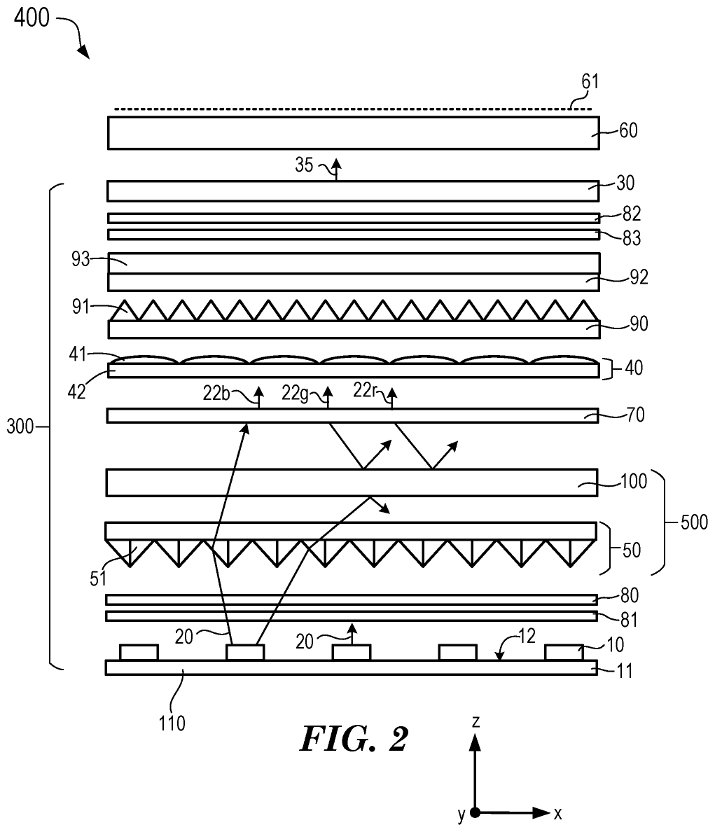

FIG. 2 is a side view of a display system including any of the embodiments of optical stacks and backlights as described herein. For example, optical stack 500 of FIG. 1 is included in the embodiment of the display system shown in FIG. 2. In some embodiments, display system 400 may include a backlight 300 including optical stack 500, and a display panel 60 configured to receive light emitted by backlight 300 and to form an image 61.

In some embodiments, backlight 300 includes a plurality of discrete spaced apart light sources 10 (e.g., light-emitting diodes), a reflective polarizer 30 disposed on the plurality of spaced apart light sources 10, a first optical diffuser 40 disposed between the reflective polarizer 30 and the plurality of light sources 10, and a second optical diffuser 50 disposed between the reflective polarizer 30 and the plurality of light sources 10 and including a plurality of retroreflective elements 51 arranged in a regular two-dimensional array. In some embodiments, the light sources may be arranged two-dimensionally (e.g., along the plane defined by x-axis and the y-axis) on a first substrate 11. In some embodiments, the first substrate 11 may be substantially reflective at least in regions 12 between the plurality of light sources 10. In some embodiments, the at least regions 12 of the first substrate 11 between the light sources 10 may have an average optical reflectance of at least 50%, or at least 60%, or at least 70%, or at least 80%, or at least 90% in the visible wavelength range.

In some embodiments, reflective polarizer 30 is configured such that, for a substantially normally incident light and for a visible (human-visible) wavelength range extending from about 420 nm to about 680 nm, the reflective polarizer has an average optical reflectance of at least 60%, or at least 70%, or at least 80%, or at least 90%, or at least 95% when the incident light is polarized along an in-plane first direction (e.g., polarized along the x-axis as shown in FIG. 2) and an average optical transmittance of at least 60%, or at least 70%, or at least 80%, or at least 90%, or at least 95% when the incident light is polarized along an in-plane orthogonal second direction (e.g., the y-axis of FIG. 2).

In some embodiments, first optical diffuser 40 may include a plurality of positive microlenses 41 arranged in a regular two-dimensional array on first optical diffuser 40. In some embodiments, the positive microlenses 41 may be disposed on a common second substrate 42. In some embodiments, the positive microlenses may have focal lengths between about 10 microns and about 100 microns. In some embodiments, in a plan view (e.g., along z-axis), the positive microlenses may cover greater than about 60%, or greater than about 65%, or greater than about 70%, or greater than about 75%, or greater than about 80%, or greater than about 85%, or greater than about 90% of the first optical diffuser.

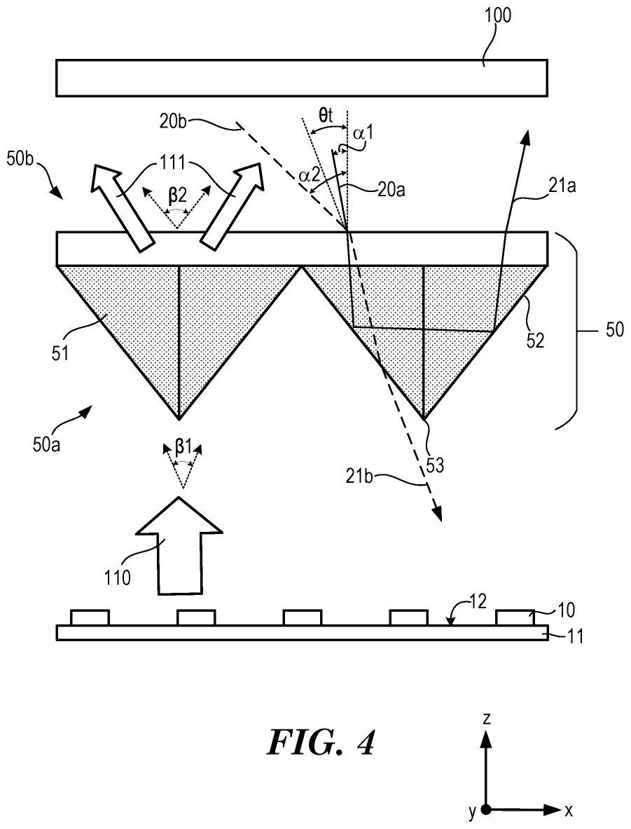

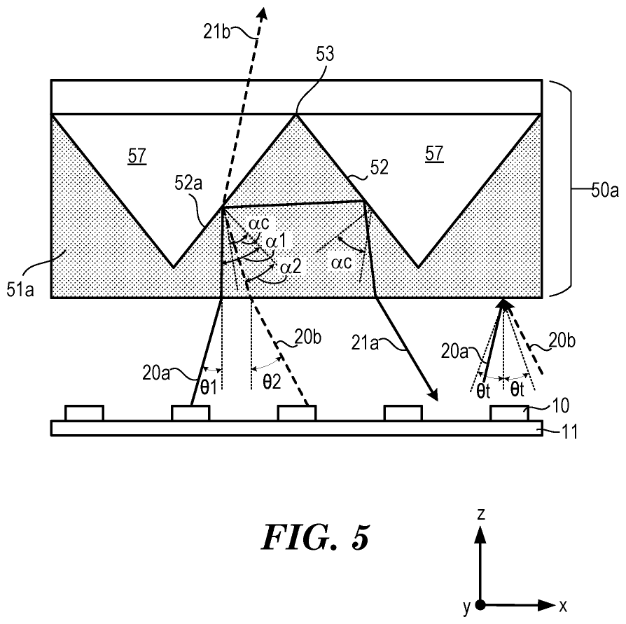

In some embodiments, second optical diffuser 50 includes a plurality of retroreflective elements 51 arranged in a regular two-dimensional array, as discussed for FIG. 1. In some embodiments, the second optical diffuser may be configured to receive the emitted light 20 and retroreflect the received light for incident angles less than a predetermined threshold value and transmit at least 60%, or at least 65%, or at least 70%, or at least 75%, or at least 80%, or at least 85%, or at least 90% of the received light for incident angles greater than the predetermined threshold value (see also FIGS. 4-5 for additional detail on the second optical diffuser).

In some embodiments, the reflective polarizer 30 and the first optical diffuser 40 and second optical diffuser 50 may be substantially co-extensive in length (e.g., along the x-axis) and width (e.g., y-axis) with the plurality of light sources 10. In some embodiments, the reflective polarizer may include a plurality of polymeric layers numbering at least 10, or at least 50, or at least 100, or at least 200, or at least 300, or at least 400, or at least 500 in total, and each of the polymeric layers may have an average thickness of less than about 500 nm, or less than about 400 nm, or less than about 300 nm, or less than about 200 nm, or less than about 150 nm, or less than about 100 nm. In some embodiments, the reflective polarizer may further include at least one skin layer disposed on the plurality of polymeric layers, the at least one skin layer having an average thickness of greater than about 500 nm, or about 750 nm, or about 1000 nm (see also FIG. 7).

In some embodiments, backlight 300 may further include a light converting film 70 disposed between the reflective polarizer 30 and the plurality of discrete spaced apart light sources 10. In some embodiments, light converting film 70 may include one or more light converting materials configured to receive the emitted light 20 from the light sources 10 and convert at least portions of the received emitted light to blue light 22b, green light 22g, and red light 22r.

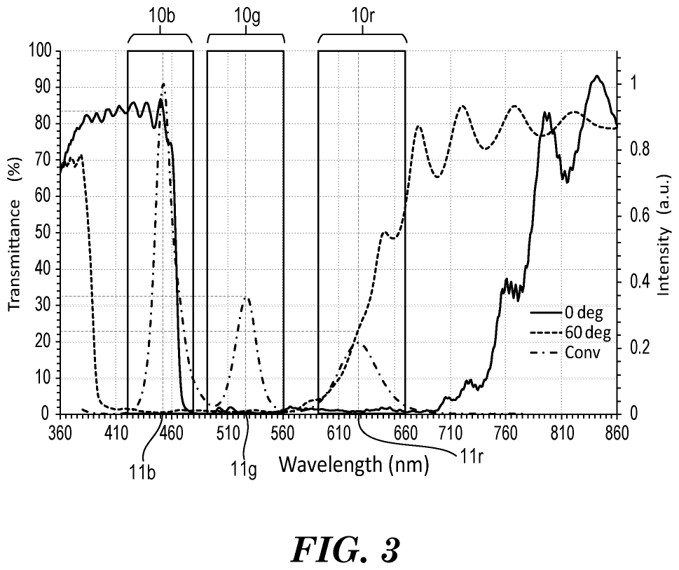

In some embodiments, optical stack 500 may further include optical filter 100 (see also FIG. 1) disposed between the light converting film 70 and the second optical diffuser 50. In some embodiments, optical filter may include a plurality of polymeric layers numbering at least 10, or at least 50, or at least 100, or at least 200, or at least 300, or at least 400, or at least 500 in total, and each of the polymeric layers may have an average thickness of less than about 500 nm, or less than about 400 nm, or less than about 300 nm, or less than about 200 nm, or less than about 150 nm, or less than about 100 nm (see also FIG. 7). In some embodiments, for a substantially normally incident light polarized along each of the in-plane first and second directions, the optical filter may have an average optical transmittance of greater than about 50%, or greater than about 55%, or greater than about 60%, or greater than about 65%, or greater than about 70%, or greater than about 75%, or greater than about 80%, or greater than about 85% for a blue wavelength range extending from about 420 nm to about 480 nm (see wavelength range 10b, FIG. 3) and an optical reflectance of greater than about 50%, or greater than about 55%, or greater than about 60%, or greater than about 65%, or greater than about 70%, or greater than about 75%, or greater than about 80%, or greater than about 85%, or greater than about 90% for each of a green wavelength range extending from about 490 nm to about 520 nm (see wavelength range 10g, FIG. 3) and a red wavelength range extending from about 530 nm to about 680 nm (see wavelength range 10r, FIG. 3).

In some embodiments, backlight 300 may further include one or more third optical diffusers 80, 81 disposed between second optical diffuser 50 and light sources 10 and configured to scatter the emitted light. In some embodiments, backlight 300 may further include one or more fourth optical diffusers 82, 83 disposed between reflective polarizer 30 and first optical diffuser 40 and configured to scatter the emitted light. In some embodiments, backlight 300 may further include a first prismatic film 90 disposed between the reflective polarizer 30 and light sources 10. In some embodiments, first prismatic film 90 may include a plurality of first prisms 91 extending along a first longitudinal direction (e.g., along the y-axis of FIG. 2). In some embodiments, backlight 300 may further include a second prismatic film 92 disposed between the reflective polarizer 30 and first prismatic film 90. In some embodiments, second prismatic film 92 may include a plurality of second prisms 93 extending along a second longitudinal direction (e.g., along the x-axis of FIG. 2) different from the first longitudinal direction.

In some embodiments, at least one of the light sources 10 of backlight 300 may be configured to emit ultraviolet light having a wavelength less than about 420 nm. In some embodiments, at least one of the light sources 10 of backlight 300 may be a blue light emitting light source configured to emit blue light having a wavelength between about 420 nm and about 480 nm. In some embodiments, at least one of the light sources 10 of backlight 300 may be a green light emitting light source configured to emit green light having a wavelength between about 490 nm and about 560 nm. In some embodiments, at least one of the light sources 10 of backlight 300 may be a red light emitting light source configured to emit red light having a wavelength between about 590 nm and about 670 nm.

FIG. 3 is a chart plotting the optical characteristics of an embodiment of a backlight according to the present description, such as backlight 300 of FIG. 1. The chart of FIG. 3 plots three lines, the intensity of light from the light converting film 70 (such as light converting film 70 of FIG. 2, as a “dash-dot” line; refer to the “Intensity” label on the right side of the chart), and the transmittance percentage of the optical film 100 (FIG. 2) at both a 0-degree angle of incidence (solid line) and a 60-degree angle of incidence (dashed line). Light converting film 70 transmits light in at least a first blue wavelength 11b in a blue wavelength range 10b extending between about 420 nm to about 480 nm, at least a first green wavelength 11g in a green wavelength range 10g extending between about 490 nm and about 560 nm, and at least a first red wavelength 11r in a red wavelength range 10r extending between about 590 nm and about 670 nm.

In some embodiments, for light incident at a first incident angle less than about 10 degrees, or less than about 8 degrees, or less than about 6 degrees, or less than about 4 degrees, or less than about 2 degrees or less than about 1 degree (e.g., substantially normally incident light, shown as the 0-degree, solid line of FIG. 3), optical filter 100 may have an optical transmittance greater than about 60%, or greater than about 65%, or greater than about 70%, or greater than about 75%, or greater than about 80%, or greater than about 85% (e.g., refer to the transmittance percentage of wavelength 11b on the solid line of FIG. 3). In some embodiments, optical filter 100 may have an optical transmittance of less than about 50%, or less than about 45%, or less than about 40%, or less than about 35%, or less than about 30%, or less than about 25%, or less than 20% for a second incident angle greater that about 40 degrees, or greater than about 45 degrees, or greater than 50 degrees, or greater than about 55 degrees, or greater than about 60 degrees (e.g., the 60-degree dashed line on FIG. 3). For example, refer to the transmittance percentage of wavelength 11b on the dashed line on FIG. 3, showing nearly 0% transmission.

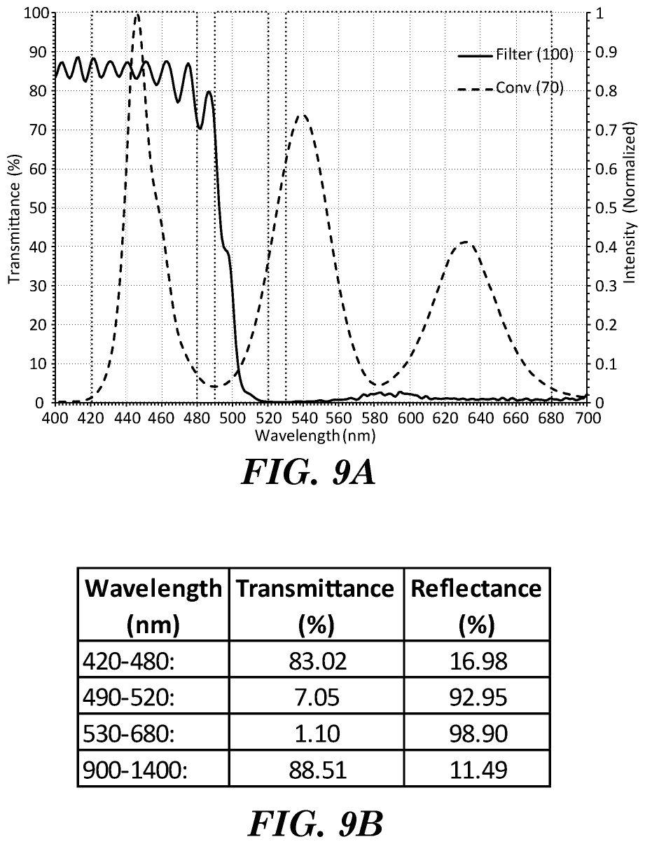

In some embodiments, for a substantially normally incident light polarized along each of the in-plane first and second directions, the optical filter may have an average optical transmittance of greater than about 50%, or greater than about 55%, or greater than about 60%, or greater than about 65%, or greater than about 70%, or greater than about 75%, or greater than about 80%, or greater than about 85% for the blue wavelength 10b range extending from about 420 nm to about 480 nm, and an optical reflectance of greater than about 50%, or greater than about 55%, or greater than about 60%, or greater than about 65%, or greater than about 70%, or greater than about 75%, or greater than about 80%, or greater than about 85%, or greater than about 90% for each of the green wavelength range 10g and the red wavelength range 10r. See FIGS. 9A-9B for additional details on the optical transmittance and reflectance of these layers.

FIGS. 4-5 provide additional details of an optically diffusing film featuring a plurality of retroreflective elements, such as optical diffuser 50 of FIGS. 1 and 2. Looking first at FIG. 4, optically diffusing film (optical diffuser) 50 may include a plurality of retroreflective elements 51 disposed on a first side 50a of optical diffuser 50. In some embodiments, first side 50a of optical diffuser 50 may face the plurality of light sources 10 on first substrate 11, and an opposing second side 50b of optical diffuser 50 may face optical filter 100. In some embodiments, each of the plurality of retroreflective elements 51 may comprise a pyramid shape (e.g., a cube corner) with a peak 53 and surfaces 52 defining at least a first optical interface through which light rays may pass or be reflected, depending on the angle of incidence. See FIG. 7 for additional detail on a cube corner retroreflective element.

In some embodiments, one of the functions of optical diffuser 50 may be that of a light-spreading film. That is, a light beam 110 emitted by light sources 10 may have a first maximum cone angle 131 (e.g., 60 degrees) before passing through optical diffuser 50, producing a light beam 111 with a second maximum cone angle β2 larger than β1 (e.g., 120 degrees) after passing through optical diffuser 50. In some embodiments, when optical diffuser 50 is combined with other films in an optical stack (such as optical filter 100), the result may be an improvement in optical properties of the display (e.g., improved uniformity of the backlight).

In some embodiments, optical diffuser 50 may be configured to receive a first light 20a, 20b at a first wavelength (e.g., a human-visible wavelength) emitted by a light sources 10 and retroreflect the received first light 20a for incident angles α1 less than a predetermined threshold value θt as retroreflected light 21a, and transmit at least 60%, or at least 65%, or at least 70%, or at least 75%, or at least 80%, or at least 85%, or at least 90% of the received first light 20b for incident angles α2 greater than the predetermined threshold value θt as transmitted light 21b.

In some embodiments, for the first wavelength, the optical filter 100 may have an optical transmittance of greater than about 60%, or greater than about 65%, or greater than about 70%, or greater than about 75%, or greater than about 80%, or greater than 85% for a first incident angle less than about 10 degrees, or less than about 8 degrees, or less than about 6 degrees, or less than about 4 degrees, or less than about 2 degrees, or less than about 1 degree, and an optical transmittance of less than about 50%, or less than about 45%, or less than about 40%, or less than about 35%, or less than about 30%, or less than about 25%, or less than about 20% for a second incident angle greater that about 40 degrees, or greater that about 45 degrees, or greater that about 50 degrees, or greater that about 55 degrees, or greater that about 60 degrees.

FIG. 5 is a side view of an alternate embodiment of an optically diffusing film featuring a plurality of retroreflective elements, wherein the retroreflective elements provide an optical interface embedded in an optical diffusing layer. In the embodiment of FIG. 5, optical interface 52 and peak 53 are embedded inside of optically diffusing layer (optical diffuser) 50a, creating voids of air 57. In embodiment 50a, light 20a emitted by light sources 10 at an angle θ1 enters into inverted pyramid (corner-cube) structures 51a and impinge on inner surface 52a at an angle of incidence α1 to surface 52a. As angle of incidence α1 is greater than angle αc, which defines the largest angle from the normal to surface 52a that will be transmitted by surface 52a, light 20a is reflected (by total internal reflection) off surfaces 52a/52 back toward light sources 10 as reflected light 21a. On the other hand, light 20b emitted by light sources 10 at an angle θ2 enters into inverted pyramid (corner-cube) structures 51a and impinge on inner surface 52a at an angle of incidence α2 to surface 52a. As angle of incidence α2 is less than angle αc, light 20b is transmitted through surface 52a as emitted light 21b. As shown on the right-hand side of FIG. 5, light 20a (which is emitted at initial angle θ1) is within (smaller than) angle θt, and light 20b (which is emitted at initial angle θ2), is outside (larger than) θt. It should be noted that, in some embodiments, voids 57 may be at least partially filled with an optically clear material with an index of refraction different that inverted structures 51a and still provide the described functionality.

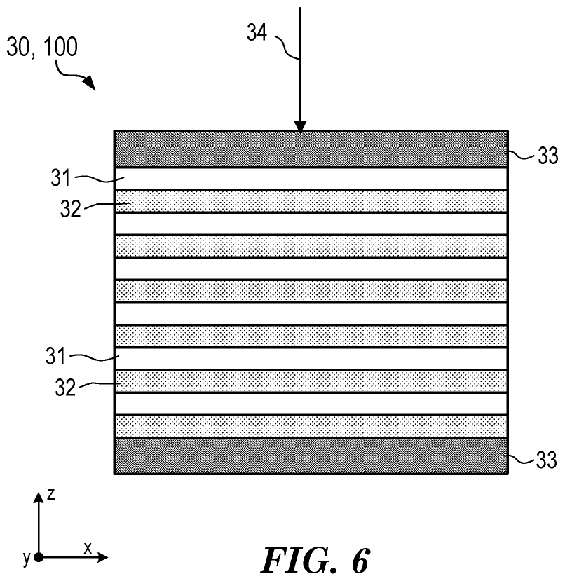

FIG. 6 provides a side view of the layered construction of a multilayer optical film, including reflective polarizer 30 and optical filter 100 of the embodiment of FIG. 2. In some embodiments, at least one of the reflective polarizer 30 and optical filter 100 include a plurality of alternating different polymeric first layers 31 and second layers 32 numbering at least 10, or at least 50, or at least 100, or at least 200, or at least 300, or at least 400, or at least 500 in total. In some embodiments, each of the polymeric first layers 31 and second layers 32 may have an average thickness of less than about 500 nm, or about 400 nm, or about 300 nm, or about 200 nm, or about 150 nm, or about 100 nm. In some embodiments, polymeric first layers 31 may have an index of refraction which differs from the index of refraction of polymeric second layers 32. By configuring the index of refraction, thickness, and orientation of alternating polymeric first layers 31 and polymeric second layers 32, it is possible to create optical films which have characteristics such as those shown in FIG. 3 or as described elsewhere herein. As discussed elsewhere herein, these characteristics may be different for incident light 34, based on the value of the angle of incidence, θ. For example, the chart of FIG. 3, shows the optical characteristics seen for light that is incident on optical film 100 at an angle of incidence which is substantially normal to the surface of the film (i.e., θ=0 degrees, the solid line) as well as the optical characteristics seen for light at a non-zero angle of incidence θ (e.g., θ=60 degrees). In some embodiments, the at least one of the first film 40 and second film 50 may further include at least one skin layer 33, which may have an average thickness of greater than about 500 nm, or about 750 nm, or about 1000 nm.

FIG. 7 shows an embodiment of a retroreflective element based on a cube corner structure, according to the present description. As shown in FIG. 7, in some embodiments, at least one of the retroreflective elements (such as retroreflective elements 51 as described elsewhere herein) of the second optical diffuser (optical diffuser 50) may include a pyramid shape (e.g., the cube corner shown in FIG. 7) having at least three sides 52a, 52b, and 52c meeting at a peak 53, which include at least three peak angles α_{ab}, α_{ac}, α_{bc} formed by adjacent sides of the three sides 52a, 52b, and 52c. In some embodiments, the at least three sides 52a, 52b, and 52c may be configured to totally internally reflect received light (e.g., rays 20c and 20d) for the incident angles less than the predetermined threshold value (as described elsewhere herein). In some embodiments, each of the at least three peak angles α_{ab}, α_{ac}, α_{bc} may be between about 85 degrees and about 95 degrees.

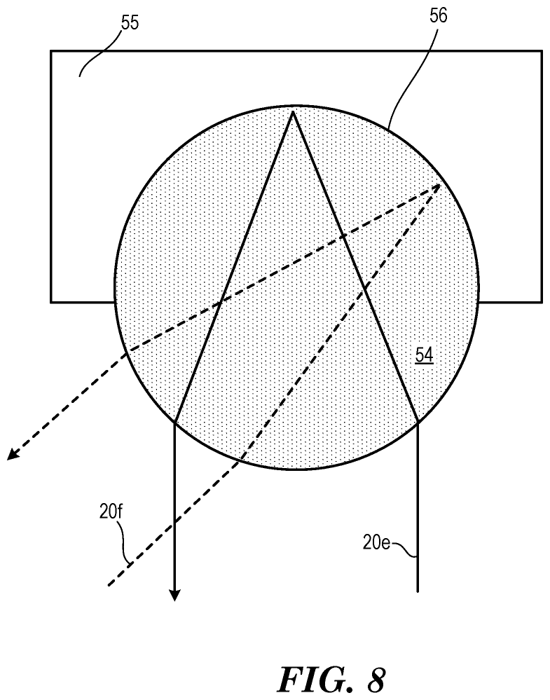

FIG. 8 shows an alternate embodiment of a retroreflective element based on a spherical bead, according to the present description. In some embodiments, at least one of the retroreflective elements (such as retroreflective elements 51 as described elsewhere herein) of the second optical diffuser (optical diffuser 50) may be a substantially spherical solid bead 54 partially embedded in a material 55 to define an optical interface 56 therebetween material 55 and bead 54. In some embodiments, the optical interface 56 may be configured to totally internally reflect the received light (e.g., rays 20e, 200 for the incident angles less than the predetermined threshold value (as described elsewhere herein). In some embodiments, material 55 may be air.

Finally, FIGS. 9A and 9B include a chart and summary table showing optical characteristics for an optical filter for use in an optical stack, according to the present description. FIG. 9A is a chart similar to the chart of FIG. 3, but shows only a plot of the optical transmittance percentage for the optical filter 100 (e.g., optical filter 100 of FIG. 1, shown as a solid line) and the light intensity seen at the light converting film 70 (e.g., light converting film 70 of FIG. 2). FIG. 9B is a table summarizing the transmittance percentages (and corresponding reflectance percentages) for light of various wavelength ranges as seen by the optical filter 100 in this example, including typical wavelength ranges for blue light (420-480 nm), green light (490-520 nm), red light (530-680 nm), and infrared light (900-1400 nm, not plotted in FIG. 9A but provided for reference).

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed:

1. A backlight for providing illumination to a display panel, the backlight comprising:
a plurality of discrete spaced apart light sources configured to emit light and arranged two-dimensionally on a first substrate substantially reflective at least in regions between the light sources;
a reflective polarizer disposed on the plurality of discrete spaced apart light sources, such that for a substantially normally incident light and for a visible wavelength range extending from about 420 nm to about 680 nm, the reflective polarizer has an average optical reflectance of at least 60% when the incident light is polarized along an in-plane first direction and an average optical transmittance of at least 60% when the incident light is polarized along an in-plane orthogonal second direction;
a first optical diffuser disposed between the reflective polarizer and the plurality of light sources and comprising a plurality of positive microlenses arranged in a regular two-dimensional array; and
a second optical diffuser disposed between the reflective polarizer and the plurality of light sources and comprising a plurality of retroreflective elements arranged in a regular two-dimensional array, the second optical diffuser configured to receive the emitted light and retroreflect the received light for incident angles less than a predetermined threshold value and transmit at least 60% of the received light for incident angles greater than the predetermined threshold value, the reflective polarizer and the first and second optical diffusers substantially co-extensive in length and width with the plurality of light sources.

2. The backlight of claim 1, wherein at least one of the light sources in the plurality of discrete spaced apart light sources is configured to emit ultraviolet light having a wavelength less than about 420 nm.

3. The backlight of claim 1, wherein at least one of the light sources in the plurality of discrete spaced apart light sources is a blue light emitting light source configured to emit blue light having a wavelength between about 420 nm and about 480 nm.

4. The backlight of claim 1, wherein at least one of the light sources in the plurality of discrete spaced apart light sources is a green light emitting light source configured to emit green light having a wavelength between about 490 nm and about 560 nm.

5. The backlight of claim 1, wherein at least one of the light sources in the plurality of discrete spaced apart light sources is a red light emitting light source configured to emit red light having a wavelength between about 590 nm and about 670 nm.

6. The backlight of claim 1, wherein the reflective polarizer comprises a plurality of polymeric layers numbering at least 10 in total, each of the polymeric layers having an average thickness of less than about 500 nm.

7. The backlight of claim 6, wherein the reflective polarizer further comprises at least one skin layer disposed on the plurality of polymeric layers and having an average thickness of greater than about 500 nm.

8. The backlight of claim 1, wherein the positive microlenses in the plurality of positive microlenses have focal lengths between about 10 microns and about 100 microns.

9. The backlight of claim 1, wherein in a plan view, the positive microlenses in the plurality of positive microlenses cover greater than about 60% of the first optical diffuser.

10. The backlight of claim 1 further comprising a light converting film disposed between the reflective polarizer and the plurality of discrete spaced apart light sources and comprising one or more light converting materials configured to receive the emitted light from the light sources and convert at least portions of the received emitted light to blue, green, and red lights.

11. The backlight of claim 10 further comprising an optical filter disposed between the light converting film and the second optical diffuser and comprising a plurality of polymeric layers numbering at least 10 in total, each of the polymeric layers having an average thickness of less than about 500 nm, such that for a substantially normally incident light polarized along each of the first and second directions, the optical filter has an average optical transmittance of greater than about 50% for a blue wavelength range extending from about 420 nm to about 480 nm and an optical reflectance of greater than about 50% for each of a green wavelength range extending from about 490 nm to about 520 nm and a red wavelength range extending from about 530 nm to about 680 nm.

12. The backlight of claim 1, wherein the at least the regions of the first substrate between the light sources have an average optical reflectance of at least 50% in the visible wavelength range.

13. The backlight of claim 1, wherein each of the retroreflective elements of the second optical diffuser comprises at least one optical interface embedded in the second optical diffuser and configured to totally internally reflect the received light for the incident angles less than the predetermined threshold value.

14. The backlight of claim 1, wherein at least one of the retroreflective elements of the second optical diffuser comprises a pyramid having at least three sides meeting at a peak comprising a at least three peak angles formed by adjacent sides in the at least three sides, the at least three sides configured to totally internally reflect the received light for the incident angles less than the predetermined threshold value.

15. The backlight of claim 1, wherein at least one of the retroreflective elements of the second optical diffuser comprises a substantially spherical solid bead partially embedded in a material to define an optical interface therebetween the material and the bead, the optical interface configured to totally internally reflect the received light for the incident angles less than the predetermined threshold value.

16. The backlight of claim 1 further comprising one or more third optical diffusers disposed between the second optical diffuser and the light sources and configured to scatter the emitted light.

17. The backlight of claim 18 further comprising one or more fourth optical diffusers disposed between the reflective polarizer and the first optical diffuser and configured to scatter the emitted light.

18. The backlight of claim 1 further comprising a first prismatic film disposed between the reflective polarizer and the light sources and comprising a plurality of first prisms extending along a first longitudinal direction.

19. The backlight of claim 20 further comprising a second prismatic film disposed between the reflective polarizer and the first prismatic film and comprising a plurality of second prisms extending along a second longitudinal direction different than the first longitudinal direction.

20. A display system comprising:
a display panel disposed on the backlight of claim 1, the display panel configured to receive the emitted light and form an image.
